(19) United States
(12) Patent Application Publication
(10) Pub. No.: US 2009/0019504 A1
(43) Pub. Date: Jan. 15, 2009

(54) Method for Managing Multimedia Data and System for Operating The Same

(76) Inventors: Jau-Hsiung Huang, Taipei (TW); Ming-Jun Chen, Tai-Nan City (TW); Bor-Ching Lin, Taipei (TW)

Correspondence Address: NORTH AMERICA INTELLECTUAL PROPERTY CORPORATION, P.O. BOX 506, MERRIFIELD, VA, 22116, US

(21) Appl. No.: 11/845,772

(22) Filed: Aug. 27, 2007

(30) Foreign Application Priority Data
Jul. 9, 2007 (TW) 096124953

(51) Int. Cl. H04N 7/173

(52) U.S. Cl. 725/109

(57) ABSTRACT

A method for managing multimedia data includes receiving video data corresponding to a program, analyzing the video data for generating at least a sequence of streaming data corresponding to at least a predetermined content of the program, and outputting at least a sequence of streaming data to an electronic device via Internet, completely or selectively.

### BACKGROUND OF THE INVENTION

1. Field of the Invention

The present invention relates to a method and system for managing multimedia data, and more particularly, to a method and system for managing multimedia data by analyzing multimedia data for generating a predetermined content corresponding to a program.

2. Description of the Prior Art

With the population of Internet and multimedia applications, a user can install a multimedia center in the house for receiving, recording, transforming, broadcasting, or editing multimedia data such as audio, video, images, and etc. The multimedia center can be a digital image or audio source capable of connecting to the Internet, so as to store multimedia data, receive signals, and perform management for client players or subscriber systems. For example, in applications of the multimedia center for family video/audio entertainment, a personal computer (PC) can be a family multimedia server, and a set-top-box (STB) is utilized for sending video data to digital multimedia players (DMP) installed in several rooms. A multimedia device with a TV tuner can receive video data from different channels, record programs at a predetermined time, store the recorded content in a hard disk, and access or sent data from the disk afterward. Therefore, the multimedia center can be regarded as a personal video recorder (PVR).

On the other hand, a user can use digital multimedia players, such as HDTV (high definition television) and DVD (digital versatile disc) players, or mobile devices capable of connecting to the Internet, such as mobile phones and personal digital assistants (PDA), for connecting to the multimedia center via Internet to display specified multimedia files. However, downloading multimedia files usually takes long time and high bandwidth. In order to enhance efficiency, the management between the multimedia server of the multimedia center and the subscriber system is very important.

### SUMMARY OF THE INVENTION

It is therefore a primary objective of the invention to provide a method for managing multimedia data and a system for operating the same.

The present invention provides a method for managing multimedia data. The method comprises receiving video data corresponding to a program, analyzing the video data for generating a plurality of streaming data sequences corresponding to a plurality of predetermined contents of the program, and outputting the plurality of streaming data sequences to an electronic device via the Internet, completely or selectively.

The present invention further provides a system for managing multimedia data. The system comprises a receiving device for receiving video data corresponding to a program, an analyzing device for analyzing the video data for generating a plurality of streaming data sequences corresponding to a plurality of predetermined contents of the program, and a transceiver for outputting the plurality of streaming data sequences to an electronic device via Internet, completely or selectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a multimedia center according to an embodiment of the present invention.

FIG. 2 illustrates a flow chart of a process for managing multimedia data according to an embodiment of the present invention.

### DETAILED DESCRIPTION

Streaming data is one of the primary ways for sending and playing multimedia data in multimedia applications over the Internet, which means that multimedia files are divided into small packages by a server of the multimedia center and delivered to subscriber devices continuously via Internet. After the multimedia files are delivered to the subscriber devices in the form of streaming data, small packages corresponding to the multimedia files are combined and displayed by a multimedia program installed in the subscriber devices.

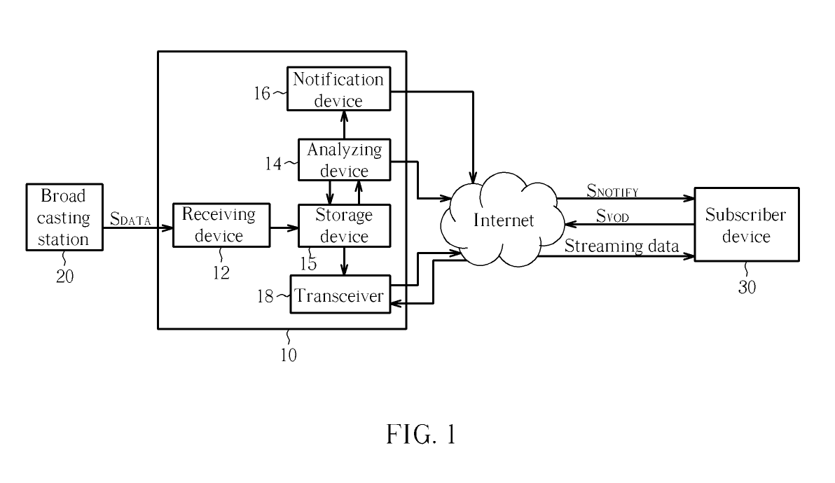

Please refer to FIG. 1. FIG. 1 illustrates a block diagram of a multimedia center 10 according to an embodiment of the present invention. The multimedia center 10 comprises a receiving device 12, an analyzing device 14, a storage device 15, a notification device 16, and a transceiver 18. The receiving device 12 receives image data S_{DATA} related to a program from a broadcasting station 20 and stores the image data S_{DATA} into the storage device 15. The analyzing device 14 analyzes the image data S_{DATA} for generating streaming data S1_{STREAM}˜SN_{STREAM} related to at least a predetermined content of the program and stores the streaming data S1_{STREAM}˜SN_{STREAM} back into the storage device 15. The analysis process of the analyzing device 14 further comprises filtering. When the image data S_{DATA} are sent into the analyzing device 14, each streaming data sent out from the analyzing device 14 are filtered, and contents of input and output are not the same. After finishing analyzing the image data S_{DATA}, the notification device 16 delivers a notification message S_{NOTIFY} to a subscriber device 30 via Internet. After receiving the notification message S_{NOTIFY}, a user delivers a video-on-demand message S_{VOD} related to a predetermined content of the program to the transceiver 18 based on the user's demand or the like through the subscriber device 30. According to different video-on-demand messages S_{VOD}, the transceiver 18 delivers one, several, or all of the streaming data S1_{STREAM}˜SN_{STREAM} to the subscriber device 30 via Internet. The subscriber device is capable of connecting to Internet, and can be a portable device, such as a mobile phone, PDA, and the like, capable of achieving a location free function.

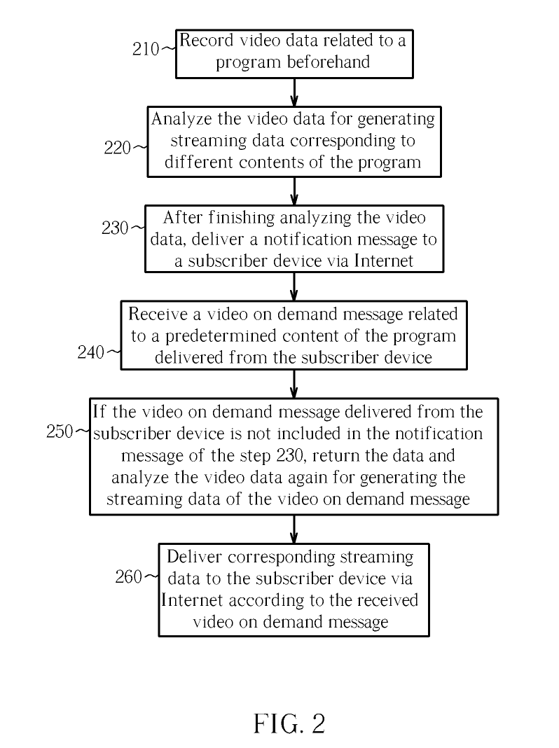

Please refer to FIG. 2. A flow chart shown in FIG. 2 illustrates a process for managing multimedia data according to an embodiment of the present invention, and comprises following steps:

Step 210: Record video data related to a program beforehand.

Step 220: Analyze the video data for generating streaming data corresponding to different contents of the program.

Step 230: After finishing analyzing the video data, deliver a notification message to a subscriber device via Internet.

Step 240: Receive a video-on-demand message related to a predetermined content of the program delivered from the subscriber device.

Step 250: If the video-on-demand message delivered from the subscriber device is not included in the notification message of the step 230, return the data and analyze the video data again for generating the streaming data of the video-on-demand message.

Step 260: Deliver corresponding streaming data to the subscriber device via Internet according to the received video-on-demand message.

The present invention records the video data related to a program beforehand in step 210 and analyzes the video data in step 220 according to programs styles and user demands. The following examples illustrate some applications of the present invention.

In the first application, the primary content of the program comprises advertisement interludes. If the user receives all contents of the program via Internet, the user may execute forwarding to pass the advertisement parts, which not only takes bandwidth for downloading contents related to the advertisement parts but also takes time for executing forwarding. Under this situation, in step 220, the video data can be analyzed and the advertisement parts of the program are detected, and the advisement parts are further deleted to generate the streaming data corresponding to the primary content of the program. The present invention can detect the advisement parts of the program by black frame detection, scene change detection or channel logo detection, which are well known for those skilled in the art and will not be narrated in detail.

In the second application, the program is related to a sports competition. The user may not have enough time to watch the whole sports game or the user is interested in some essential or highlight parts of the sports competition. If the user receives all contents of the sports competition via Internet, the user may execute forwarding to find the essential parts, which takes bandwidth and time to download all contents of the sports competition and to execute forwarding, and the essential parts may be omitted when executing forwarding. In such case, in step 220 the video data is analyzed to detect predetermined events in the sports competition (e.g. homers, strikeouts, or scorings in a baseball game, scorings, three-point shots, or slam dunks in a basketball game, field goal tries, scorings, or penalty kicks in a soccer game, game starts represent by a gesture of a referee or game results represented by showing a name of a contestant on a board in a sumo competition, etc), and generates corresponding streaming data according to the content of the video data related to the predetermined events. The predetermined events can be set according to sports program styles and user's favor, and analyzed programs corresponding to the streaming data received by the user can comprise the essence or highlight scenes of the original sports program.

In the third application, the program is an awarding ceremony. The user may not have enough time to watch the whole awarding ceremony or the user is interested in a result of a specific reward in the awarding ceremony. If the user receives the whole content of the awarding ceremony, the user may execute forwarding to find parts of the specific reward, which not only takes bandwidth to download the whole content of the awarding ceremony but also takes time to execute forwarding. Under this situation, in step 220, the video data is analyzed to detect predetermined events (e.g. highlight scenes of awarding of specific reward, appearance of award cups or certificates, roll calls by an anchorman, presentation of bouquets by audience, and playing of accompaniment music) in the awarding ceremony, and generates an analyzed corresponding streaming data according to the content of the video data related to the predetermined events. The predetermined events can be set according to awarding ceremony styles and user's favor, and programs corresponding to the streaming data received by the user can be regarded as the essence or highlight scenes of the original awarding ceremony.

The analyzing step in step 220 may further comprise filtering. The original video data and the corresponding streaming data undergo filtering, to make their contents and lengths not always be the same, and to achieve the streaming data conforming predetermined options; for example, the options for user to choose can be five-minute length, ten-minute length or the whole essence parts. Moreover, in step 240, when the user cannot find the length he or she wants to download, the user may input his/her viewing requirement such as 15-minute length, and request for repeating steps 220 and 230.

After analyzing the video data (step 220), in step 230, the notification message is delivered to the subscriber device via the Internet so as to notify the user of permission to receive the video data related to the program. If the user wants to receive the content of the program without advertisement parts (e.g. the first application), the content related to the predetermined event (e.g. the second application) or abstracts of the program (e.g. the third applications), the user can deliver the corresponding video-on-demand message to the multimedia center through the subscriber device. Finally, the multimedia center delivers the corresponding streaming data to the subscriber device via Internet according to the received video-on-demand message.

Moreover, in the second application, if the user receives the video data of essential parts of homers, strikeouts, scorings, or the whole game of a baseball game, the users can choose one or several of them by inputting selection through the corresponding video-on-demand messages, and transmit the video-on-demand messages to the multimedia center by the subscriber device. Then, the multimedia center delivers the corresponding streaming data to the subscriber device via Internet according to the received video-on-demand messages. Of course, scorings, three-point shots, or slam dunks in a basketball game, field goal tries, scorings, or penalty kicks in a soccer game, game starts represent by a gesture of a referee or game results represented by showing a name of a contestant on a board in a sumo competition are all included in the application.

When the video-on-demand message is not included in the notification message of step 230, step 250 is executed to analyze the video data again for generating the streaming data corresponding to the video-on-demand message. For example, the user receives the whole essence parts of a baseball game, while the user expects to receive the essence parts of homers, strikeouts, or scorings. In such situation, step 250 is executed to analyze and re-generate the streaming data corresponding to the video-on-demand message for the user.

The above-mentioned applications are exemplary embodiments of the present invention, and will not limit the present invention. The present invention can use the subscriber devices capable of connecting to Internet, such as HDTV, DVD, mobile phones, PDA, etc.

The present invention can analyze the video data for generating the streaming data corresponding to different contents of the program and deliver the corresponding streaming data to the subscriber device via Internet according to the video-on-demand message delivered by the user. Therefore, the present invention delivers user-demanded data and does not take bandwidth or time to deliver all contents of a program, to enhance system efficiency and save Internet resources.

Those skilled in the art will readily observe that numerous modifications and alterations of the device and method may be made while retaining the teachings of the invention.

What is claimed is:

1. A method for managing multimedia data comprising:
(a) receiving video data corresponding to a program;
(b) analyzing the video data for generating a plurality of streaming data sequences corresponding to a plurality of predetermined contents of the program; and
(c) outputting the plurality of streaming data sequences to an electronic device via Internet, completely or selectively.

2. The method of claim 1 further comprising outputting a notification message to the electronic device after finishing analyzing the video data.

3. The method of claim 2 further comprising receiving a user demand message corresponding to one of the plurality of predetermined contents after finishing outputting the notification message.

4. The method of claim 3 further comprising returning the data and analyzing the video data again for generating the streaming data of the user demand message if the user demand message is not included in the notification message.

5. The method of claim 3, wherein in the step (c) when outputting a plurality of streaming data sequences of the plurality of streaming data sequences to the electronic device, further comprising outputting according to a user demand message.

6. The method of claim 1, wherein in the step (b) when analyzing the video data, further comprising selecting a part of content of the video data for generating the plurality of streaming data sequences corresponding to the plurality of predetermined contents of the program.

7. The method of claim 1, wherein the step (c) further comprises outputting the plurality of streaming data sequences to a mobile device via Internet.

8. The method of claim 1 further comprising storing the video data corresponding to the program and the plurality of streaming data sequences corresponding to the plurality of predetermined contents of the program.

9. The method of claim 1, wherein the program is a program with advertisement interludes.

10. The method of claim 9, wherein analyzing the video data for generating the plurality of streaming data sequences corresponding to the plurality of predetermined contents of the program comprises filtering the advertisement interludes of the program for generating a predetermined content.

11. The method of claim 1, wherein the program is a sports program.

12. The method of claim 11, wherein the program comprises a baseball game.

13. The method of claim 12, wherein the plurality of predetermined contents comprise at least one strikeout scene.

14. The method of claim 12, wherein the plurality of predetermined contents comprise at least one score scene.

15. The method of claim 11, wherein the program comprises a basketball game.

16. The method of claim 15, wherein the plurality of predetermined contents comprise at least one three-point shot scene.

17. The method of claim 15, wherein the plurality of predetermined contents comprise at least one slam-dunk scene.

18. The method of claim 15, wherein the plurality of predetermined contents comprise at least one score scene.

19. The method of claim 11, wherein the program comprises a soccer game.

20. The method of claim 19, wherein the plurality of predetermined contents comprise at least one score scene.

21. The method of claim 19, wherein the plurality of predetermined contents comprise at least one penalty kick scene.

22. The method of claim 1, wherein the program is an awarding ceremony.

23. The method of claim 22, wherein the plurality of predetermined contents comprise a predetermined reward awarding scene.

24. The method of claim 22, wherein the plurality of predetermined contents comprise roll calls of an anchorman scene.

25. The method of claim 22, wherein the plurality of predetermined contents comprise presenting bouquets of audience scene.

26. A system for managing multimedia data comprising:
a receiving device for receiving video data corresponding to a program;
an analyzing device for analyzing the video data for generating a plurality of streaming data sequences corresponding to a plurality of predetermined contents of the program; and
a transceiver for outputting the plurality of streaming data sequences to an electronic device via Internet, completely or selectively.

27. The system of claim 26 further comprising a notification device for outputting a notification message to the electronic device after the analyzing device finishes analyzing the video data.

28. The system of claim 27, wherein the transceiver is further utilized for receiving a user demand message corresponding to one of the plurality of predetermined contents, and for outputting a plurality of streaming data sequences of the plurality of streaming data sequences to the electronic device according to the user demand message.

29. The system of claim 28, wherein the transceiver is further utilized for returning the data to the analyzing device and the analyzing device is further utilized for analyzing the video data again for generating the streaming data of the user demand message if the user demand message is not included in the notification message.

30. The system of claim 26, wherein the analyzing device is utilized for selecting a part of content of the video data for generating the plurality of streaming data sequences corresponding to the plurality of predetermined contents of the program.

31. The system of claim 26 further comprising a storage device for storing the video data corresponding to the program and the plurality of streaming data sequences corresponding to the plurality of predetermined contents of the program.

32. The system of claim 26, wherein the electronic device is a mobile device.

33. The system of claim 26, wherein the program is a program with advertisement interludes.

34. The system of claim 33, wherein the analyzing device filters the advertisement interludes of the program for generating the plurality of predetermined contents.

35. The system of claim 26, wherein the program comprises a sports program.

36. The system of claim 35, wherein the program comprises a baseball game.

37. The system of claim 36, wherein the plurality of predetermined contents comprise at least one strikeout scene.

38. The system of claim 36, wherein the plurality of predetermined contents comprise at least one score scene.

39. The system of claim 35, wherein the program comprises a basketball game.

40. The system of claim 39, wherein the plurality of predetermined contents comprise at least one three-point shot scene.

41. The system of claim 39, wherein the plurality of predetermined contents comprise at least one slam-dunk scene.

42. The system of claim 39, wherein the plurality of predetermined contents comprise at least one score scene.

43. The system of claim 35, wherein the program comprises a soccer game.

44. The system of claim 43, wherein the plurality of predetermined contents comprise at least one score scene.

45. The system of claim 43, wherein the plurality of predetermined contents comprise at least one penalty kick scene.

46. The system of claim 26, wherein the program comprises an awarding ceremony.

47. The system of claim 46, wherein the plurality of predetermined contents comprise a predetermined reward awarding scene.

48. The system of claim 46, wherein the plurality of predetermined contents comprise roll calls of an anchorman scene.

49. The system of claim 46, wherein the plurality of predetermined contents comprise presenting bouquets of audience scene.
